(19) United States
(12) Patent Application Publication
(10) Pub. No.: US 2005/0040349 A1
(43) Pub. Date: Feb. 24, 2005

(54) Mapping apparatus and method of controlling the same

(75) Inventors: Eui Seok Kum, Suwon City (KR); Yeon Jae Lee, Suwon City (KR); Byeong Kap Choi, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/827,357

(22) Filed: Apr. 20, 2004

(30) Foreign Application Priority Data
Aug. 19, 2003 (KR) 2003-57230

(51) Int. Cl. G01J 1/42; G01N 21/86; G11B 5/10

(52) U.S. Cl. 250/559.29; 250/559.4

(57) ABSTRACT

A mapping apparatus, and a method of controlling the same, including a cassette having a plurality of slots into which planar objects are inserted, and at least one reflector which reflects light beams irradiated into the plurality of slots; and a sensor unit having a light emitting unit and a light receiving unit, the sensor unit determining whether the planar objects have been inserted into the respective slots by determining whether a light beam, irradiated from the light emitting unit, is reflected from the reflector and then received by the light receiving unit.

### CROSS-REFERENCE TO RELATED APPLICATIONS

This application claims the benefit of Korean Patent Application No. 2003-57230, filed Aug. 19, 2003 in the Korean Intellectual Property Office, the disclosure of which is incorporated herein by reference.

### BACKGROUND OF THE INVENTION

1. Field of the Invention

The present invention relates, in general, to an apparatus for manufacturing semiconductor devices, and, more particularly, to a mapping apparatus, and a method of controlling the same, which examines whether semiconductor wafers or flat panel displays have been inserted into slots of a cassette that transfers and/or receives semiconductor wafers or flat panel displays, and obtains slot information.

2. Description of the Related Art

Generally, wafers used in a semiconductor manufacturing process, or Liquid Crystal Display (LCD) glasses used in a flat panel display manufacturing process similar to the semiconductor manufacturing process, are moved and/or received after being respectively inserted into a plurality of slots formed in a cassette. An operation of withdrawing a wafer or LCD glass from the cassette and putting it into a process, or an operation of loading a processed wafer or processed LCD glass on the cassette, is performed by a transfer robot.

For the transfer robot to withdraw a wafer or LCD glass from a cassette, a mapping operation for the cassette must be performed in advance. The mapping operation includes an operation of determining which slots in the cassette have wafers or LCD glasses inserted therein and which slots are empty, and an operation of inspecting the alignment of the wafers or LCD glasses inserted into the slots. If an inserting or withdrawing operation is attempted when an accurate mapping operation is not performed, the accuracy of the mapping operation may be decreased and products may be damaged.

### SUMMARY OF THE INVENTION

Accordingly, it is an aspect of the present invention to provide a mapping apparatus, and a method of controlling the same, which is capable of performing an accurate mapping operation even though a distance between a cassette and a transfer robot is long and a surrounding environment of a port on which the cassette is loaded is complicated.

Additional aspects and/or advantages of the invention will be set forth in part in the description which follows and, in part, will be obvious from the description, or may be learned by practice of the invention.

The above and/or other aspects are achieved by providing a mapping apparatus including a cassette and a sensor unit. The cassette has a plurality of slots into which planar objects are inserted, and at least one reflector which reflects light beams irradiated into the plurality of slots. The sensor unit has a light emitting unit and a light receiving unit. Further, the sensor unit determines whether the planar objects have been inserted into the respective slots by determining whether a light beam, irradiated from the light emitting unit, is reflected from the reflector and then received by the light receiving unit.

The above and/or other aspects may be achieved by providing the following mapping apparatus, including a cassette and a sensor unit. The cassette has a plurality of slots, each with a certain thickness and width, provided in parallel to allow planar objects to be inserted therein, and at least one reflector to reflect light beams irradiated into the plurality of slots. The sensor unit has a light emitting unit to irradiate a light beam and a light receiving unit to receive the light beam when reflected from the reflector. Further, the sensor unit determines whether the planar objects have been inserted into the respective slots by irradiating a light beam while moving along a thickness direction of the slots, and determining whether the irradiated light beam is reflected from the reflector and then received by the light receiving unit.

The above and/or other aspects may be achieved by providing a flat panel display mapping apparatus including a cassette and a sensor unit. The cassette has a plurality of slots, each with a certain thickness and width, provided in parallel to allow flat panel displays to be inserted therein, and at least one reflector to reflect light beams irradiated into the plurality of slots. The sensor unit has a laser generating unit to irradiate a laser beam and a light receiving unit to receive the laser beam when reflected from the reflector. Further, the sensor unit determines whether the flat panel displays have been inserted into the respective slots by irradiating a laser beam while moving along a thickness direction of the slots, and determining whether the irradiated laser beam is reflected from the reflector and then received by the light receiving unit.

The above and/or other aspects may be achieved by providing the following mapping apparatus, including a cassette, a sensor, and a control unit. The cassette has a plurality of slots, each with a certain thickness and width, provided in parallel to allow planar objects to be inserted therein, and at least one reflector provided lengthwise along the plurality of slots to reflect light beams irradiated into the slots. The sensor has a light emitting unit to irradiate a light beam and a light receiving unit to receive the light beam when reflected from the reflector. The control unit irradiates a light beam while moving the sensor along a longitudinal direction of the reflector, detects electrical characteristic variations generated in response to the irradiated light beam being reflected from the reflector and then received by the light receiving unit, and obtains position information of the slots with planar objects inserted therein through a position of the sensor at a time the electrical characteristic variations are detected.

The above and/or other aspects may be achieved by providing a method of controlling a mapping apparatus including a cassette and a sensor unit. The cassette has a plurality of slots, each with a certain thickness and width, provided in parallel to allow planar objects to be inserted therein, and at least one reflector provided lengthwise along the slots to reflect light beams irradiated into the slots. The sensor has a light emitting unit to irradiate a light beam and a light receiving unit to receive the light beam when reflected from the reflector. In the control method, the light beam is irradiated while the sensor moves along a longitudinal direction of the reflector. Electrical characteristic variations, generated by the sensor in response to the irradiated light beam being reflected from the reflector and then received by the light receiving unit, are detected. Position information of the slots with planar objects inserted therein is obtained through a position of the sensor at a time the electrical characteristic variations are detected.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view showing an LCD glass mapping apparatus according to an embodiment of the present invention;

FIG. 2 is a view showing a relationship between a mounting angle of a reflecting plate and a laser beam irradiation angle of a laser sensor in the LCD glass mapping apparatus of FIG. 1;

FIGS. 3A to 3C are views showing a difference between a circular wafer and a square LCD glass at the time of mapping using a circular laser sensor;

FIG. 4 is a side view of the LCD glass mapping apparatus of FIG. 1; and

FIG. 5 is a flowchart of a method of controlling the LCD glass mapping apparatus according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

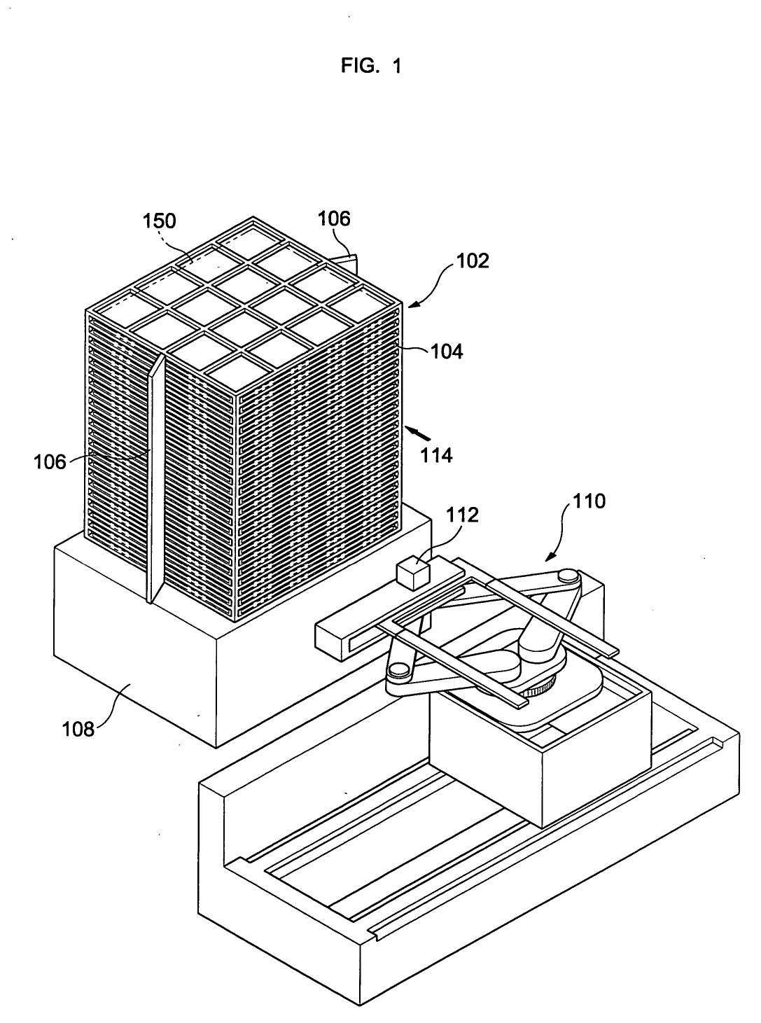

Embodiments of a mapping apparatus and a method of controlling the same will be described in detail with reference to FIGS. 1 to 5. FIG. 1 is a view showing an LCD glass mapping apparatus according to an embodiment of the present invention. As shown in FIG. 1, a plurality of slots 104, each with a certain width and thickness, are provided in parallel, with the width of the slots extending in a horizontal direction, in a cassette 102 placed on a port 108. The slots 104 receive a plurality of LCD glasses 150, which are planar objects. If the slots are provided to allow the LCD glasses 150 to be inserted vertically into the slots 104, the plurality of slots 104 are provided so that the width of the slots 104 extend in a vertical direction while the slots 104 are provided in parallel in the cassette 102. One LCD glass 150 is respectively inserted into each of the slots 104 in a direction of an arrow 114 shown in FIG. 1. Reflecting plates 106 are provided at both lateral ends of the slots 104, which are both side surfaces of the cassette 102, respectively, to form a certain angle with a front surface of the cassette 102. Alternatively, only one reflecting plate 106 may be provided.

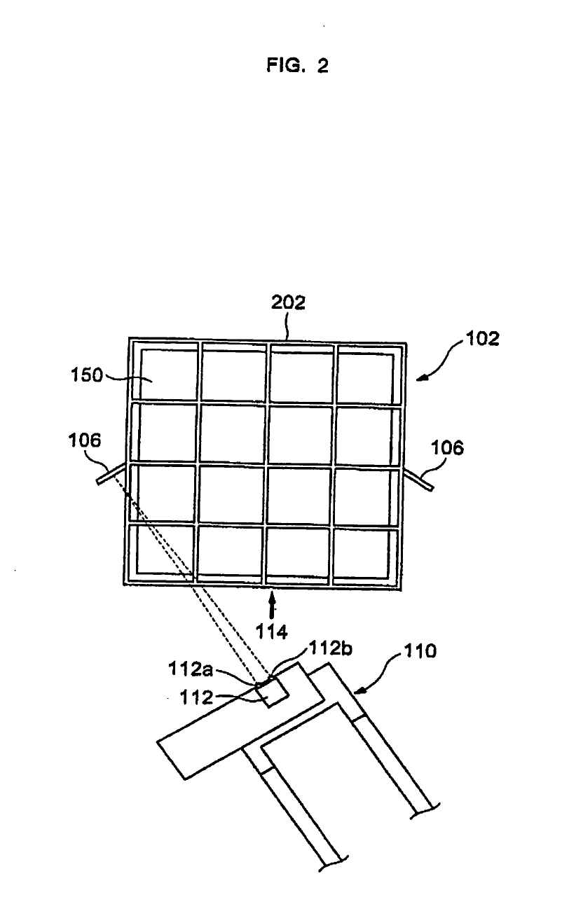

A laser sensor 112 is placed on a transfer robot 110. The laser sensor 112 includes a light emitting unit 112a to irradiate a laser beam and a light receiving unit 112b to receive a returned laser beam when the irradiated laser beam is reflected and returned from a corresponding reflecting plate 106. In this embodiment of the present invention, a construction in which the light emitting unit 112a irradiates a laser beam and the light receiving unit 112b receives a laser beam reflected and returned from the reflecting plate 106 is used to determine whether the slots 104 in the cassette 102 are empty or have LCD glasses 150 inserted therein. For this operation, a mounting angle of the reflecting plates 106 and a laser beam irradiation angle of the laser sensor 112 must be determined so that an irradiated laser beam passes through an empty slot and is reflected from a corresponding reflecting plate 106 and then received by the light receiving unit 112b of the laser sensor 112. The above procedure is described with reference to FIG. 2.

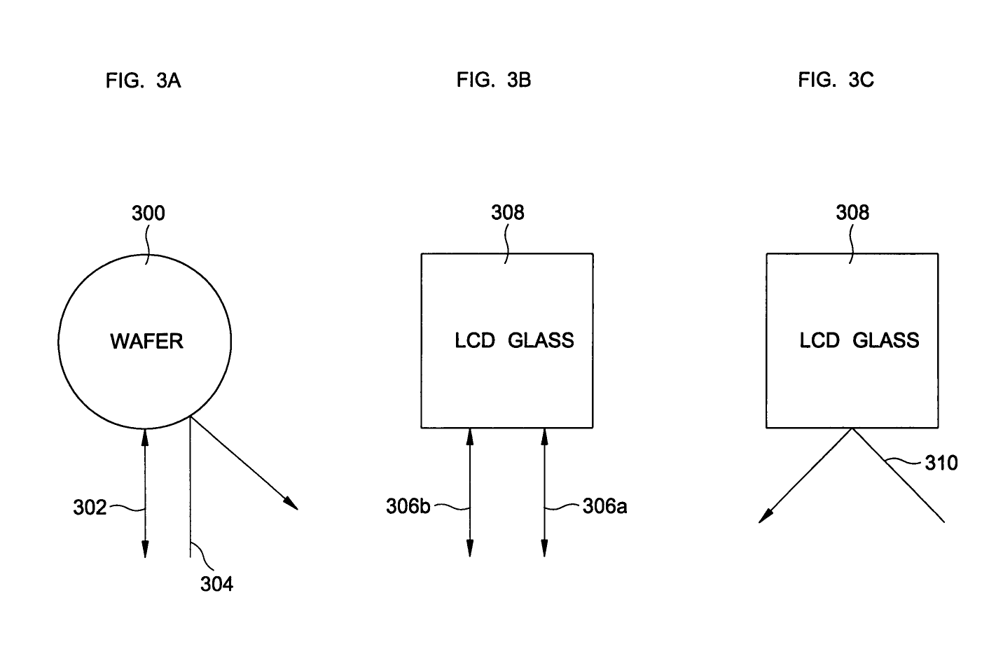

FIG. 2 is a view showing a relationship between a mounting angle of the reflecting plates and a laser beam irradiation angle of the laser sensor 112 in the LCD glass mapping apparatus of FIG. 1. As shown in FIG. 2, the laser sensor 112, placed on the transfer robot 110, preferably irradiates a laser beam so that the laser beam forms an acute (or obtuse) angle with the front surface of the cassette 102. In this case, the reflecting plates 106 are preferably provided to form an acute (or obtuse) angle with the side surfaces of the cassette 102. In this way, it is preferable to determine the angles of the laser sensor 112 and the reflecting plates 106 so that a laser beam irradiated from the laser sensor 112 is reflected from the corresponding reflecting plate 106 and then received by the light receiving unit 112b of the laser sensor 112. If the use of the cassette 102 is limited to the loading of wafers, the reflecting plates 106 may be provided on a back surface 202 of the cassette 102 as well as the side surfaces thereof. The above operation is described in detail with reference to FIGS. 3A to 3C.

FIGS. 3A to 3C are views showing a difference between a circular wafer 300 and a square LCD glass 308 at the time of mapping using a circular laser sensor. As shown in FIG. 3A, since the wafer 300 has a circular shape, if a laser beam 302 is irradiated from a position in front of a center of the wafer 300, an incident laser beam and a reflected laser beam have the same path. Accordingly, it is impossible to determine whether the reflected laser beam, received by the light receiving unit of the laser sensor, is obtained from a reflecting plate provided on a back surface of a cassette for wafers, or from a wafer inserted into a slot. Therefore, in the case where a reflecting plate is provided on the back surface of the cassette for wafers, it is preferable that an irradiation position of the laser sensor is offset from the center of the wafer, such as a laser 304 shown in FIG. 3A, and a beam irradiated from the laser sensor forms an acute or obtuse angle with a reflecting surface of the reflecting plate.

Differently from the circular wafer 300, an LCD glass 308 has a square shape. Therefore, if a laser beam is irradiated at a right angle to the front surface of the LCD glass 308, the irradiated laser beam is reflected from the LCD glass 308 and received by the light receiving unit of the laser sensor regardless of a position where the laser beam is irradiated. Therefore, it is impossible to determine whether a reflected laser beam, as shown by lasers 306a and 306b in FIG. 3B, received by the light receiving unit of the laser sensor, is obtained from a reflecting plate provided on a back surface of a cassette for LCD glasses, or from the LCD glass 308 inserted into a slot. Consequently, in the case of the cassette for LCD glasses, it is preferable to obliquely irradiate a laser beam 310 so that the laser beam 310 forms an acute (or obtuse) angle with the front surface of the LCD glass 308, and to provide the reflecting plate on the side surface of the cassette 102 so that the reflecting plate forms a right angle with the obliquely irradiated laser beam 310, as shown in FIG. 3C.

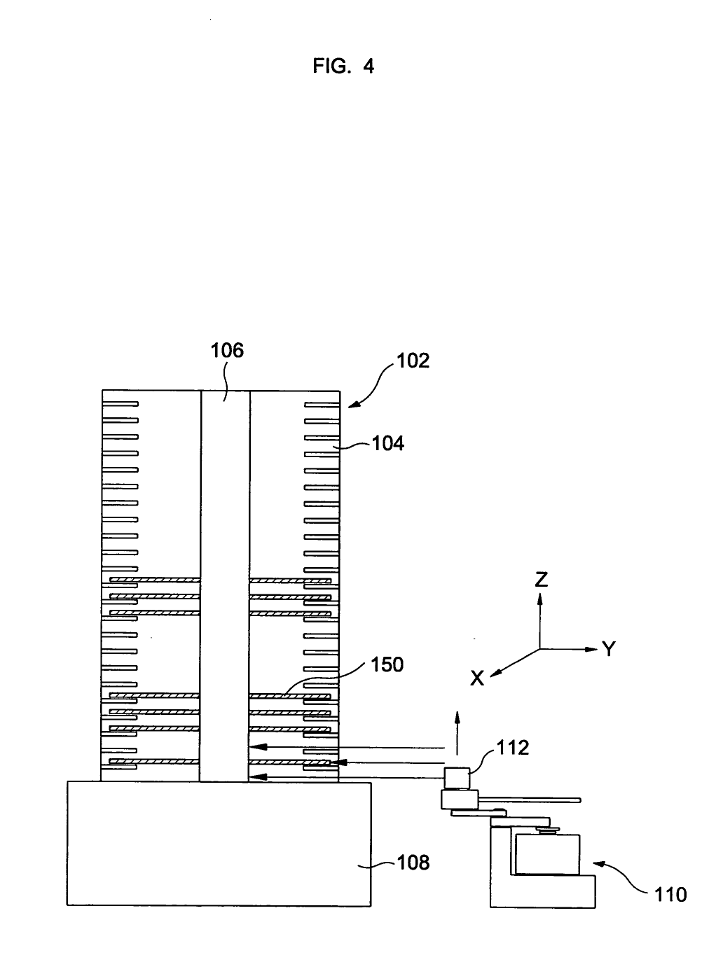

In FIG. 1, a construction is depicted in which the plurality of slots 104 are provided in parallel so that LCD glasses 150 are horizontally inserted in the cassette 102. In this case, the LCD glasses 150 are horizontally inserted into the slots 104, respectively. In this way, when the LCD glasses 150 are horizontally inserted into the slots 104 of the cassette 102 and loaded in a vertical direction, the transfer robot 110 examines whether an LCD glass 150 has been inserted into each of the slots 104 by irradiating laser beams while moving the laser sensor 112 upward and downward. This operation is described with reference to FIG. 4.

FIG. 4 is a side view showing the LCD glass mapping apparatus of FIG. 1. As shown in FIG. 4, the transfer robot 110 moves along a Z axis (a vertical direction) while irradiating a laser beam onto the reflecting plate 106 on the side of the cassette 102. While the transfer robot 110 moves along the Z axis, a reflected laser beam is not received by the light receiving unit 112b of the laser sensor 112 from a position of a slot in which an LCD glass is inserted. Conversely, a laser beam reflected from the reflecting plate 106 is received by the light receiving unit 112b from a position of an empty slot. The laser sensor 112 generates output voltages with different levels when the reflected laser beam is received and not received by the light receiving unit 112b, respectively. A slot in which an LCD glass is inserted and an empty slot are distinguished from each other using the different output voltage levels of the above two cases. In addition, Z axis values at the positions of the slots determined to have an LCD glass inserted therein while the transfer robot 110 moves along the Z axis are stored in an additional memory to obtain mapping data. When the mapping data is obtained, it is preferable to calibrate the mapping data with an initial position of the laser sensor 112, i.e., a position where a first slot is provided in an upper or lower portion of the cassette 102 (a start position of the slots 104), with a pitch between the slots 104 and the like taken into consideration.

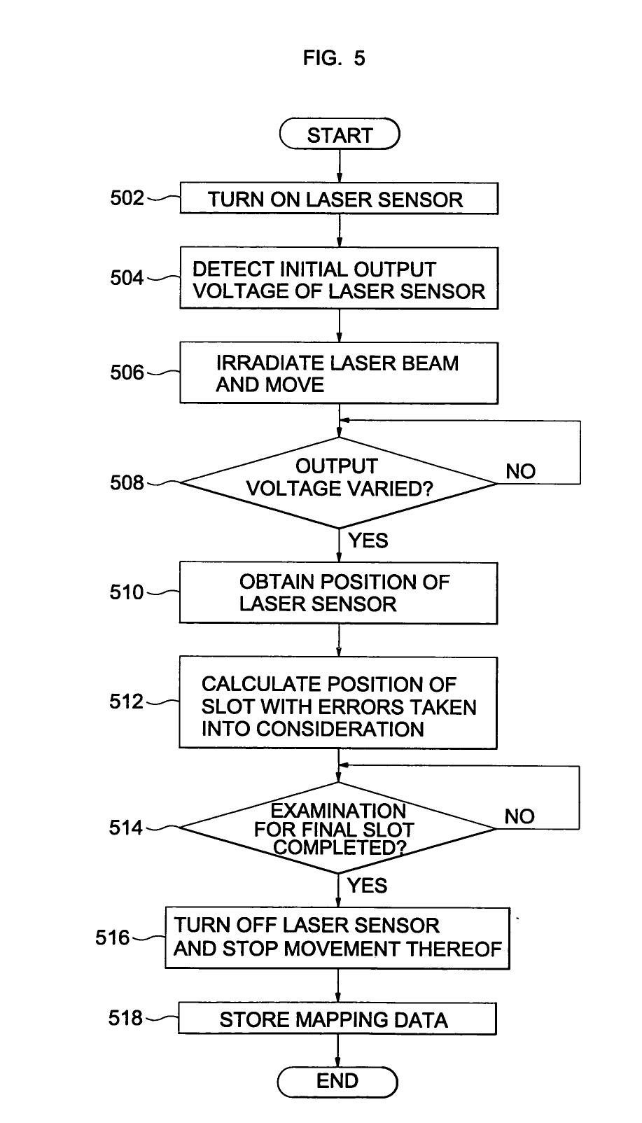

FIG. 5 is a flowchart of a method of controlling the LCD glass mapping apparatus, according to an embodiment of the present invention. As shown in FIG. 5, the laser sensor 112 is turned on in operation 502. Thereafter, the level of an initial output voltage of the laser sensor 112 is detected and set to a reference value in operation 504. When the transfer robot 110 moves along the Z axis while irradiating a laser beam, it is monitored to determine whether an output voltage of the laser sensor 112 varies from the previously detected initial output voltage by a certain value or more in operations 506 and 508. When the output voltage of the laser sensor 112 varies from the previously detected initial output voltage by a certain value or more, the position of the laser sensor 112 on the Z axis at that time is obtained in operation 510. A current position of the laser sensor 112 is precisely calculated with mechanical errors (the initial position of the laser sensor, the pitch between slots, etc.) taken into consideration in operation 512. Through the above method, if an examination has been completed up to a final slot in operation 514, the laser sensor 112 is turned off, and the movement of the transfer robot is stopped, in operation 516. Mapping data obtained with respect to the respective slots is stored in an additional memory. Thereafter, when the transfer robot 110 withdraws the LCD glass 150 from the cassette 102, or additionally inserts a new LCD glass 150 into an empty slot of the cassette 102, the transfer robot 110 performs related operations with reference to the stored mapping data.

As is apparent from the above description, the present invention provides a mapping apparatus, and a method of controlling the same, which employs a laser sensor, thus obtaining accurate mapping results even in the case where a distance between a cassette and the laser sensor is relatively long, and in which reflecting plates are provided on the side surfaces of the cassette and a mapping operation for the cassette is performed according to whether or not a laser beam is reflected from the reflecting plates, thus obtaining accurate mapping results without being influenced by the surrounding environment of the cassette.

Although a few embodiments of the present invention have been shown and described, it would be appreciated by those skilled in the art that changes may be made in these embodiments without departing from the principles and spirit of the invention, the scope of which is defined in the claims and their equivalents.

1. A mapping apparatus, comprising:
a cassette having a plurality of slots into which planar objects are inserted, and at least one reflector which reflects light beams irradiated into the plurality of slots; and
a sensor unit having a light emitting unit and a light receiving unit, the sensor unit determining whether the planar objects have been inserted into the respective slots by determining whether a light beam, irradiated from the light emitting unit, is reflected from the reflector and then received by the light receiving unit.

2. The mapping apparatus according to claim 1, wherein the reflector and the light receiving unit are provided so that an angle of the reflector and/or a position of the light receiving unit allow the light beam irradiated from the light emitting unit to be reflected from the reflector and received by the light receiving unit.

3. The mapping apparatus according to claim 1, wherein the sensor unit is provided so that a light beam irradiation angle of the light emitting unit and/or a position of the light receiving unit prevent a reflected light beam from being received by the light receiving unit when the light beam irradiated from the light emitting unit is reflected from a corresponding planar object inserted into the cassette.

4. The mapping apparatus according to claim 1, wherein:
the plurality of slots are provided in parallel to the allow planar objects to be inserted therein; and
the at least one reflector is provided at at least one lateral end of the plurality of slots.

5. The mapping apparatus according to claim 1, wherein:
the plurality of slots have inlets formed therein so as to allow circular planar objects to be inserted therein; and
the at least one reflector is provided at positions opposite to the inlets of the slots to be offset from a center position of the slots.

6. The mapping apparatus according to claim 1, wherein the at least one reflector is provided to form an acute angle with a side surface of the cassette.

7. The mapping apparatus according to claim 4, further comprising a back reflector provided on a back inner surface of the slots.

8. The mapping apparatus according to claim 7, wherein an irradiation position of the sensor unit is offset from a center position of the slots.

9. A mapping apparatus, comprising:
a cassette having a plurality of slots, each with a predetermined thickness and width, provided in parallel to allow planar objects to be inserted therein, and at least one reflector to reflect a light beam irradiated into the plurality of slots; and
a sensor unit having a light emitting unit to irradiate the light beam and a light receiving unit to receive the light beam when reflected from the reflector, the sensor unit determining whether the planar objects have been inserted into the respective slots by irradiating the light beam while moving along a thickness direction of the slots, and determining whether the irradiated light beam is reflected from the reflector and then received by the light receiving unit.

10. The mapping apparatus according to claim 9, wherein the reflector and the light receiving unit are provided so that an angle of the reflector and/or a position of the light receiving unit allow the light beam irradiated from the light emitting unit to be reflected from the reflector and received by the light receiving unit.

11. The mapping apparatus according to claim 9, wherein the sensor unit is provided so that a light beam irradiation angle of the light emitting unit and/or a position of the light receiving unit prevent a reflected light beam from being received by the light receiving unit when the light beam irradiated from the light emitting unit is reflected from a corresponding planar object inserted into the cassette.

12. The mapping apparatus according to claim 9, wherein the at least one reflector is provided at at least one lateral end of the plurality of slots.

13. The mapping apparatus according to claim 9, wherein:
the plurality of slots have inlets formed therein so as to allow the planar objects to be inserted therein; and
the at least one reflector is provided at positions opposite to the inlets of the slots to be offset from a center position of the slots.

14. A flat panel display mapping apparatus, comprising:
a cassette having a plurality of slots, each with a predetermined thickness and width, provided in parallel to allow flat panel displays to be inserted therein, and at least one reflector to reflect a light beam irradiated into the plurality of slots; and
a sensor unit having a laser generating unit to irradiate a laser beam and a light receiving unit to receive the laser beam when reflected from the reflector, the sensor unit determining whether the flat panel displays have been inserted into the respective slots by irradiating the laser beam while moving along a thickness direction of the slots, and determining whether the irradiated laser beam is reflected from the reflector and then received by the light receiving unit.

15. The flat panel display mapping apparatus according to claim 14, wherein the flat panel displays comprise liquid crystal display glasses.

16. The flat panel display mapping apparatus according to claim 14, wherein the reflector and the light receiving unit are provided so that an angle of the reflector and/or a position of the light receiving unit allow the laser beam irradiated from the laser generating unit to be reflected from the reflector and received by the light receiving unit.

17. The flat panel display mapping apparatus according to claim 14, wherein the sensor unit is provided so that a laser beam irradiation angle of the laser generating unit and/or a position of the light receiving unit prevent a reflected laser beam from being received by the light receiving unit when the laser beam irradiated from the laser generating unit is reflected from a corresponding one of the flat panel displays inserted into the cassette.

18. The flat panel display mapping apparatus according to claim 14, wherein the at least one reflector is provided at at least one lateral end of the plurality of slots.

19. The flat panel display mapping apparatus according to claim 14, wherein:
the plurality of slots have inlets formed therein so as to allow the flat panel displays to be inserted therein; and
the at least one reflector is provided at positions opposite to the inlets of the slots to be offset from a center position of the slots.

20. A mapping apparatus, comprising:
a cassette having a plurality of slots, each with a predetermined thickness and width, provided in parallel to allow planar objects to be inserted therein, and at least one reflector provided lengthwise along the plurality of slots to reflect a light beam irradiated into the slots;
a sensor having a light emitting unit to irradiate the light beam;
a light receiving unit to receive the light beam when reflected from the reflector; and
a control unit to irradiate the light beam while moving the sensor along a longitudinal direction of the at least one reflector, detect electrical characteristic variations generated in response to the irradiated light beam being reflected from the at least one reflector and then received by the light receiving unit, and obtain position information of the slots with planar objects inserted therein through a position of the sensor at a time the electrical characteristic variations are detected.

21. The mapping apparatus according to claim 20, wherein a start position of the slots and a pitch between the slots are considered in obtaining the position information of the slots.

22. A method of controlling a mapping apparatus, the mapping apparatus including a cassette having a plurality of slots, each with a certain thickness and width, provided in parallel to allow planar objects to be inserted therein, and at least one reflector provided lengthwise along the slots to reflect light beams irradiated into the slots, and a sensor having a light emitting unit to irradiate a light beam and a light receiving unit to receive the light beam when reflected from the at least one reflector, the method comprising:
irradiating the light beam while moving the sensor along a longitudinal direction of the at least one reflector;
detecting electrical characteristic variations generated by the sensor in response to the irradiated light beam being reflected from the at least one reflector and then received by the light receiving unit; and
obtaining position information of slots with planar objects inserted therein through a position of the sensor at a time the electrical characteristic variations are detected.

23. The control method according to claim 22, further comprising considering a start position of the slots and a pitch between the slots when obtaining the position information of the slots.

24. A mapping apparatus, comprising:
a receiving unit comprising:
a plurality of slots into which objects are inserted, and
at least one reflector provided at a lateral side of the plurality of slots to reflect a light beam sent through the slots; and
a sensor unit comprising:
a light emitting unit sending the light beam into the slots, and
a light receiving unit receiving the light beam reflected from the at least one reflector in response to the respective slots being empty.

25. The mapping apparatus of claim 24, wherein the at least one reflector comprises a plurality of reflectors, and a single one of the plurality of reflectors is correspondingly provided at a lateral side of each of the slots.

26. A mapping apparatus, comprising:
a receiving unit comprising:
a plurality of slots into which objects are inserted, and
at least one reflector provided at a back inner surface of the slots to be offset from a center position of the slots; and
a sensor unit sending light into the slots and receiving the light reflected from the at least one reflector in response to the respective slots being empty.

27. The mapping apparatus of claim 26, wherein the at least one reflector comprises a plurality of reflectors, and a single one of the plurality of reflectors is correspondingly provided at a back inner surface of each of the slots.
